(19) United States
(12) Patent Application Publication
(10) Pub. No.: US 2024/0222037 A1
(43) Pub. Date: Jul. 4, 2024

(54) DIELECTRIC MULTI-MATERIAL ELECTRODE DEVICES AND METHODS THEREOF

(71) Applicant: Jonathan PHILLIPS, Pacific Grove, CA (US)

(72) Inventor: Jonathan PHILLIPS, Pacific Grove, CA (US)

(21) Appl. No.: 18/400,501

(22) Filed: Dec. 29, 2023

Related U.S. Application Data
(60) Provisional application No. 63/478,298, filed on Jan. 3, 2023.

(51) Int. Cl. H01G 11/32; H01G 11/04

(52) U.S. Cl. CPC H01G 11/32; H01G 11/04

(57) ABSTRACT

A multimaterial electrode capacitor is described, which includes a first electrically conductive electrode, a second electrically conductive electrode, where the first electrically conductive electrode may include a first material and the second electrically conductive electrode may include a second material, and the first material is different than the second material. The multimaterial electrode capacitor also includes a low dielectric material or air gap disposed between the first electrically conductive electrode and the second electrically conductive electrode, where the low dielectric material has a dielectric constant of less than 10 at 1 Hz.

### REFERENCE TO RELATED APPLICATIONS

This application claims the benefit of U.S. Provisional Patent Application No. 64/478,298, filed on Jan. 3, 2023, which is hereby incorporated by reference in its entirety.

### TECHNICAL FIELD

The present teachings relate generally to dielectric multi-material electrode devices and, more particularly, to apparatus and methods for energy storage related to dielectric multi-material electrode devices.

### BACKGROUND

Dielectric multi-material electrode devices (MMEDs or MEDs) can be fabricated with a variety of designs, but in general, they all have elements of a typical parallel plate capacitor, for example, electrodes, electrically insulated from each other, separated by or surrounded by dielectric material. Such devices may be of interest in a variety of technology areas, but energy storage is of particular interest. Alternate technologies having utility in energy storage, such as supercapacitors, are typically constructed with high-surface area carbon electrodes, have maximum voltages on the order of 2.7 V, energy densities of 5-10 Wh/kg, and costs of approximately 2400-3000 $/kWh. Lithium-ion batteries are typical fabricated using graphite and lithium metal oxide electrodes, have maximum voltages on the order of 3.5 V, energy densities of 240-300 Wh/kg, and costs of approximately 160 $/kWh.

Novel paradigm supercapacitors (NPS) are known in the art, but have associated challenges, including increasing operating voltages, long-term stability, and minimization of leakage current while meeting cost targets on the order of lithium-ion batteries, or 160 $/kWh. Dielectric multi-material electrode devices have potential to use a variety of electrode and dielectric compositions, and improve metrics such as operating voltages, energy density, and cost. Challenges remain in energy storage applications utilizing such devices including meeting or exceeding requirements related to sustained number of cycles, leakage currents, voltage limits, efficiency, as well as understanding the mechanisms of charge storage related to Dielectric multi-material electrode devices.

Thus, devices and associated methods related to dielectric multi-material electrode devices that meet or exceed the aforementioned criteria are needed.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A multimaterial electrode capacitor is disclosed. The multimaterial electrode capacitor includes a first electrically conductive electrode, a second electrically conductive electrode, where the first electrically conductive electrode may include a first material and the second electrically conductive electrode may include a second material and the first material is different than the second material. The multimaterial electrode capacitor also includes a low dielectric material or air gap disposed between the first electrically conductive electrode and the second electrically conductive electrode, where the low dielectric material has a dielectric constant of less than 10 at 1 Hz. The multimaterial electrode capacitor also includes a continuous high dielectric material that covers more than half of an outer surface of the first electrically conductive electrode and the second electrically conductive electrode, where the continuous high dielectric material has a dielectric constant of more than 105 at 1 Hz. The multimaterial electrode capacitor also includes where there is no electrical connection between the first electrically conductive electrode and the second electrically conductive electrode. The multimaterial electrode capacitor also includes where the multimaterial electrode capacitor is configured to be charged with an electrical power source to a voltage greater than an open circuit voltage. Implementations of the multimaterial electrode capacitor can include where the open circuit voltage is from about 0.6 V to about 0.8 V. The multimaterial electrode capacitor is configured to be charged from about 2 to about 3 times the open circuit voltage. The multimaterial electrode capacitor is discharged to a discharge voltage which is 10% or less below the open circuit voltage. The first electrically conductive electrode may include a carbon-based material and the second electrically conductive electrode may include a metal. The second electrically conductive electrode may include aluminum, copper, titanium, or a combination thereof. The first electrically conductive electrode may include a first metal and the second electrically conductive electrode may include a second metal. The first electrically conductive electrode may include aluminum. The first electrically conductive electrode may include aluminum, copper, titanium, or a combination thereof. The second electrically conductive electrode may include a carbon-based material. The dielectric material may include a gel-like material. The dielectric material may include a may include a solid oxide powder, a liquid, and a dissolved salt. The dielectric material may include a fumed silica and a salt solution. The dielectric material may include a fumed silica, an organic liquid and a salt. The dielectric material may include a solid material saturated with a salt solution. The solid material may include a polymer. The solid material may include a fibrous solid. The salt solution may include ethylene glycol, and a salt of an alkali metal. The salt solution may include water and a salt of an alkali metal. The multimaterial electrode capacitor may include an insulating layer separating the first electrically conductive electrode from the second electrically conductive electrode, and the dielectric material covers one or more surfaces of the first electrically conductive electrode and the second electrically conductive electrode that are not in contact with the insulating layer.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic of a multimaterial electrode capacitor device, in accordance with the present disclosure.

FIG. 2 is a schematic representing an assembly method of a multimaterial electrode capacitor device, in accordance with the present disclosure.

FIG. 3 is a plot illustrating discharge data for an outer dielectric capacitor device configuration showing voltage as a function of time, in accordance with the present disclosure.

FIG. 4 is a plot illustrating energy measured over a load as a function of time, in accordance with the present disclosure.

FIG. 5 is a schematic top view of a ‘Side-by-Side MEC’ in accordance with the present disclosure.

FIG. 6 is a photograph taken of a Side-by-Side MEC prior to i) wrapping the capacitor with the absorbent electrolyte layer, and ii) before that absorbent layer was saturated with superdielectric fluid, in accordance with the present disclosure.

FIG. 7 is a plot illustrating the (voltage) discharge of a Side-by-Side MEC (FIGS. 5 and 6), measured across a 1950 Ohm load, in accordance with the present disclosure.

FIG. 8 is a record of the energy dropped across a 1950 Ohm load in an MEC Side-by-Side configuration, in accordance with the present disclosure.

FIG. 9 is a perspective schematic view of a third type of MEC capacitor, a ‘Hybrid MEC’, in accordance with the present disclosure.

FIG. 10 is a plot illustrating the performance of a Hybrid MEC, exhibiting capacitance over a number of cycles, in accordance with the present disclosure.

FIG. 11 is a plot illustrating performance of a hybrid MEC, exhibiting voltage cycles over time, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present teachings relate generally multi-material electrode devices employed as capacitors and, more particularly, to apparatus and methods for energy storage related to a multimaterial electrode capacitor (MEC).

MEC can be fabricated with a variety of designs, but in general, they all have elements of a typical parallel plate capacitor, for example, plate shaped electrodes, electrically insulated from each other, surrounded by dielectric material. They also have structural elements common to batteries such as electrodes made of different materials. Yet, MEC are neither batteries nor capacitors when operated in the voltage range above the open circuit voltage. MECs may be of interest in a variety of technology areas but energy storage is the most significant interest.

The present disclosure describes a general definition and supplies specific illustrated arrangements, of a novel class of electrical energy storage devices, Multimaterial Electrodes Capacitors (MEC). Also notable, the novel operating requirements, particularly the requirement that these novel devices operate above the open circuit voltage (OCV). The OCV is generally understood to be the voltage measured when the electrodes of an MEC are discharging through a very large resistance load, ca. 10 MOhm.

The MEC includes two electrodes, each made of a different conductive material, with no ‘matrix’ support material for either electrode, wherein these electrodes are separated by a non-conductive, low dielectric constant material. Also, the two electrodes are surrounded, partially or fully, by an electrically insulating dielectric material with a dielectric constant at <1 Hz of >10⁵ (generally referred to as a ‘superdielectric’ material in the scientific and patent literature). The device is charged, for example, with a power supply, before operation to a voltage greater than the OCV. For example, the MEC may be charged to 1.6 V as compared to a measured OCV of 0.6V. Moreover; if the device is only discharged from the initial above open circuit voltage, until it reaches the OCV of 0.6 V, the device can be recharged and discharged repeatedly with minimal corrosion of the electrodes.

The MEC is neither physically organized like a battery, nor a capacitor; although it has features found in each. Features in common with a battery include most importantly the use of electrodes made of different conductive materials. There are also significant and fundamental difference between a battery and MEC, including, most importantly, the inclusion of a high dielectric material, in fact superdieletric material, only in the MEC. Batteries do not require, and do not use high dielectric constant, or superdielectric, materials. That is, the use of superdielectric material, which is never found in batteries, is a key feature of MEC. In the absence of a dielectric material, the amount of charge stored on a MEC above the open circuit voltage (OCV) is trivial. Hence superdielectric material is intrinsic to satisfactory operation of an MEC. Similarly, batteries, having no superdielectric material, have trivial energy storage capacity above the OCV.

As noted above, an MEC includes, like a capacitor, high dielectric, particularly superdielectric, material. However, there are also features of the MEC which are not found in capacitors. First, a standard capacitor has two electrodes composed of the same material, whereas in a MEC they must be created from different electrically conductive materials. In the absence of electrodes of distinct conductive materials, the MEC capacitance on a size or weight basis is less than that of many commercial supercapacitors. Thus, it is clear distinct electrode materials are a fundamental component of MEC. Also, unlike all commercial capacitors, in an MEC the dielectric is located on the outer surfaces of the electrodes. The superdielectric on the outside leads to significant charge separation, enhances the natural voltage difference between the electrodes, and significantly enhances capacitance. Also, unlike supercapacitors, which among capacitors, most closely match the energy storage capabilities of MEC, there is no: i) high surface area material required, ii) ion conductive porous separator between electrodes, or iii) electrically conductive ‘current collectors.’

There are several types of capacitors and it is important to understand the features of MEC that are similar to and different from these various capacitors types, particularly electrolytic capacitors and supercapacitors. In terms of ‘parts’ an MEC is more like a standard electrolytic capacitor than a supercapacitor. Indeed, neither an MEC nor a electrolytic capacitor have any bulky high surface, high volume electrodes. Both employ thin (ca. ≤1 mm) conductive materials as electrodes. Also, neither is organized to allow direct transport of ions through a porous membrane as in a supercapacitor. However; there are also strong geometric distinctions between MEC and electrolytic capacitors. First, in an MEC the two electrodes are made of distinctly different materials, not so for electrolytic capacitors. Also, electrolytic capacitors have the dielectric material placed between the electrodes, whereas in an MEC the high dielectric material is never directly between the electrodes. Also, the electrodes of an electrolytic capacitor are of the same size, which is not generally the case for MEC, and in an electrolytic capacitors, the two electrodes are positioned one above the other, an organizational feature not required of MEC.

Above, it is established above that the MEC is not organized like a battery nor a capacitor. Below we establish that MEC are also not operated like either, further demonstrating that the MEC is a unique device. The key operational difference relative to batteries and capacitors is the allowed operating voltage regime. Regarding the difference with a battery: A battery is only operated at, or below the OCV. In contrast, the MEC only operates above the OCV. If operated at or below the OCV the electrodes of an MEC is effectively corrode, and hence will slowly corrode as would a battery with similar electrodes.

MEC are also not operated like capacitors. The permitted range of voltage operation for a capacitor is from the voltage to which the device is charged, until zero voltage. An MEC, over proper given voltage range will produce a voltage discharge profile nearly identical with a capacitor with the same number of Farads operated over the same proper voltage range. The proper voltage range, per above, is voltage greater than the OCV. In brief, the permitted operating voltage for an MEC, the range over which it discharges like a capacitor, is from the charged voltage until the OCV is reached. Consequently, a capacitor has no voltage operating restrictions except those imposed by material breakdown limitations, whereas an MEC can only be operated above the OCV. It should be noted that current commercial capacitors have an effective OCV of zero volts.

Next, it is established that there is a fundamental difference between the operating chemical principles of an MEC and a battery. The energy in a battery discharge essentially arises from a corrosion process of the electrodes involving the movement of ions at OCV or lower voltages. The operating voltage in a battery is determined by the DG (Gibb's Free Energy Change) of reaction when ions move from one chemical environment (e.g. anode) at high energy, to a second chemical environment (e.g. cathode). The energy of the electrons moving from anode to cathode are set by the chemical energy change of the above described chemical process. By contrast, MEC discharge, above the OCV, does not involve the movement of ions to and from the electrodes, as only electrons transit between the two electrodes via a path through a load. Hence, no corrosion occurs in an MEC.

The fundamental differences in the chemistry of batteries and MEC results in distinct voltage profiles for the two devices, as exemplified by discharge across a constant resistance load. A pre-charged MEC discharges (see examples below) through a constant resistance load with an exponentially decaying voltage profile is not expected for a battery, but rather for a capacitor. In contrast, batteries deliver a constant voltage, related to the corrosion chemistry, until near ‘end of life’ when the battery is exhausted of one of the chemical reactants and hence can no longer produce electrical energy via chemical reaction, leading to a sharp drop in delivered voltage.

The operating principle of an MEC is similar to that of a capacitor, even though the structure and operating range, as described above, are distinctly different. To wit: the energy of the transiting electrons in an MEC is not a determined by a chemical process, but rather a capacitive process. That is, the initial voltage is a function of i) capacitance and ii) the amount of charge collected on the electrodes during the charging part of the cycle. The voltage at any point in time during discharge is less than the initial voltage, and is a function (exponential) of the charge remaining on the electrodes.

An additional difference between MEC, and both capacitors and batteries, regards charging at a voltage higher than the maximum operating voltage of the MEC, called supercharging herein. (Note: In MEC, like supercapacitors, the chemistry of the electrolyte limits the maximum ‘capacitive’ voltage.) Tests show that MEC can be supercharged at voltages as much as 10× higher than the operating voltage without apparent damage to the device. This allows MEC to be charged very quickly.

One final clarification regards the OCV of an MEC. This value is related to i) any corrosion type chemistry inherent in the use of two different conductive materials, and ii) the Fermi energy difference between the two materials. The OCV is determined by the same ‘physics’ that determines the measured voltage difference in a thermocouple. Although a scientific explanation for an OCV can be produced from consideration of the above two sources, it is best simply to define it operationally. To wit: The OCV is the voltage measured between the electrodes when virtually no current is permitted to pass between them. Exemplary is the voltage measured between the two electrodes using a 10 MOhm input resistance multi-meter.

### Examples of Designs

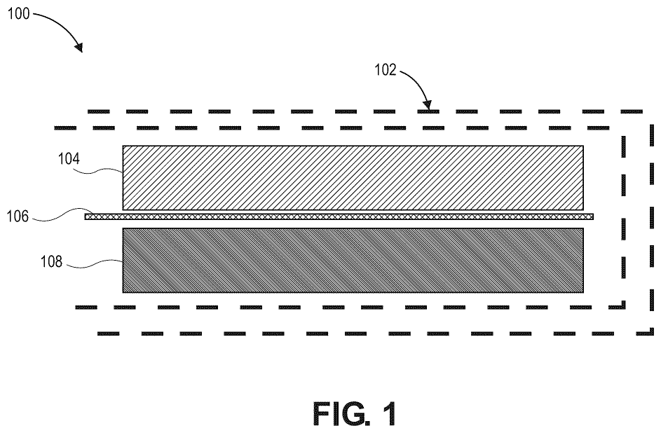

An MEC device 100 is shown in FIG. 1, which includes a first electrode 104, made from metal and a second electrode 108 made from conductive carbon. In an MEC the first electrode 104 and the second electrode 108 are composed of a different electrically conductive material. The device 100 also includes an outer dielectric layer 102, that spans the distance between them, or surrounds them. As shown, this is generally an electrically insulating matrix material into which is absorbed a significant amounts of superdielectric liquid. This ‘matrix with absorbed liquid combination’ must have a net measured dielectric constant at 0.01 Hz of greater than 100,000, and a resistance of more than 106 Ohms/cm. Between the first electrode 104 and the second electrode 108 an electrically insulating separator 106 made from low density polyethylene (LDPE) is disposed. In alternate examples, the electrically insulating separator 106 can be made from other materials having electrical insulating, and virtually zero ion diffusivity, properties such that they isolate electrical, and ionic, contact between the first electrode 104 and the second electrode 108. Exemplary materials for the matrix include fibrous non electrically conductive materials such as many types of paper, natural and artificial sponge, and gels composed of water, or other liquids, and fine ceramic powders such as fumed silica. Exemplary materials for the liquid include salts such as KI, NaCl, and the like, dissolved in water or ethylene glycol or anti-corrosion, water free, commercial antifreeze liquids. Other liquids that can be employed include acids, such as boric acid, and bases such as KOH dissolved in water, ethylene glycol, commercial anti-corrosion antifreeze or any combination thereof. Exemplary materials of the first electrode can include copper, zinc, aluminum, silver, gold, platinum, carbon-based materials, such as graphite, or other metals or transition metals, or combinations thereof. Exemplary materials of the second electrode can include copper, zinc, aluminum, silver, gold, platinum, carbon-based materials, such as graphite, or other metals or transition metals, or combinations thereof. Illustrative materials of the insulator can include any electrically insulating materials that are also not porous to ion flow. Additional materials having the appropriate properties including air, plastic films, composite materials, ceramics, or combinations thereof, which in exemplary examples can include low density, thin, polyethylene, or an air gap.

Additional aspects related to the structure of each of these components include several design considerations. First, regarding the electrodes, the conductive materials can include solid, homogeneous materials. They may or may not be mixed, supported on, or otherwise a component of an amalgam of materials. As a point of contrast, lithium-ion based secondary batteries generally have an anode composed of mixture of an extremely high surface area conductive nearly pure carbon, for example, graphene, into which lithium atoms are absorbed. Thus, the anode is a composite. The cathode for secondary batteries can include a complex oxide such as CoₓMo_{y}O_{z}. Thus, the cathode is also a complex structure. Both anode or cathode material are examples of ‘amalgam of materials’ and may not necessarily be included in the devices of the present disclosure. Non-limiting configurations of the devices as described herein can include the outer dielectric capacitor configuration as shown in FIG. 1 or a side-by-side or hybrid configuration. It is notable that the two electrodes in FIG. 1 need not be the same size.

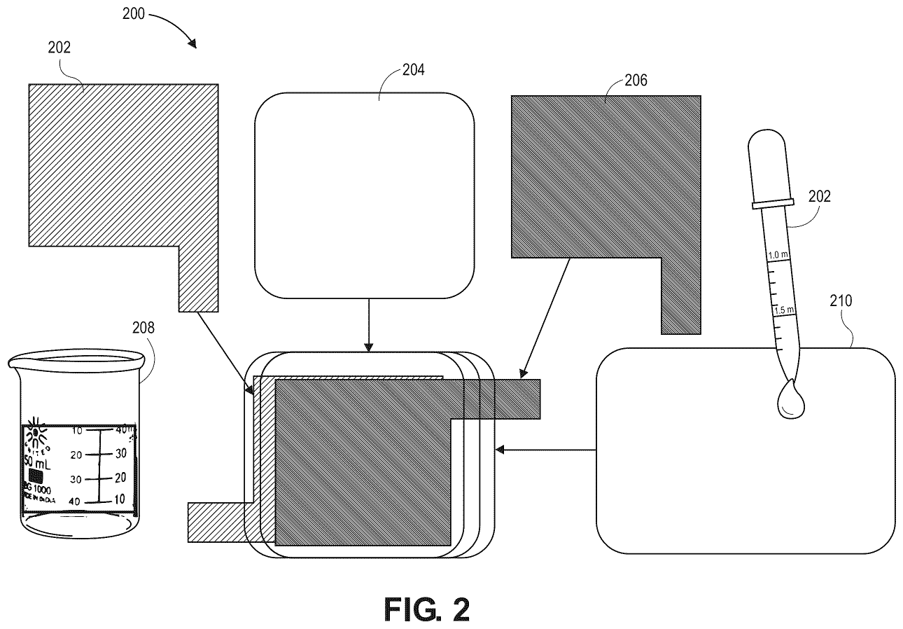

An exemplary, but not unique, assembly method 200 of constructing the outer dielectric capacitor configuration of FIG. 1, in which the first electrode 202 is aluminum and the second electrode 206 is a conductive form of carbon is illustrated in FIG. 2. First, a section of thin aluminum foil is cut to an appropriate size, including a tab for connection to an electric circuit. Second, the thin layer of LDPE is placed as an insulator layer 204, having a slightly larger dimension on top of the first electrode 202. Third, a second electrode 206 composed of conductive carbon, having the same dimensions as the aluminum foil first electrode 202, plus a tab, is placed on top of the insulating layer 404 204 such that the margins of the first electrode 202 and the second electrode 206 are aligned. The tabs of the first electrode 202 and second electrode 206 should be arranged such that the two electrodes do not touch or make any physical or electrical contact. Fourth, the two electrodes 202, 206 and separator insulator layer 204 are wrapped with a physically continuous absorbent material 210, for example, a paper towel or alternate absorbent material of the present disclosure, such that the absorbent layer 210 extends beyond the margins of the two electrodes 202, 206, generally on three sides. Fifth, the absorbent layer 210 is saturated with a superdielectric liquid 208. The structure as described, can then be covered with a thin layer of plastic, not shown herein, to reduce evaporation.

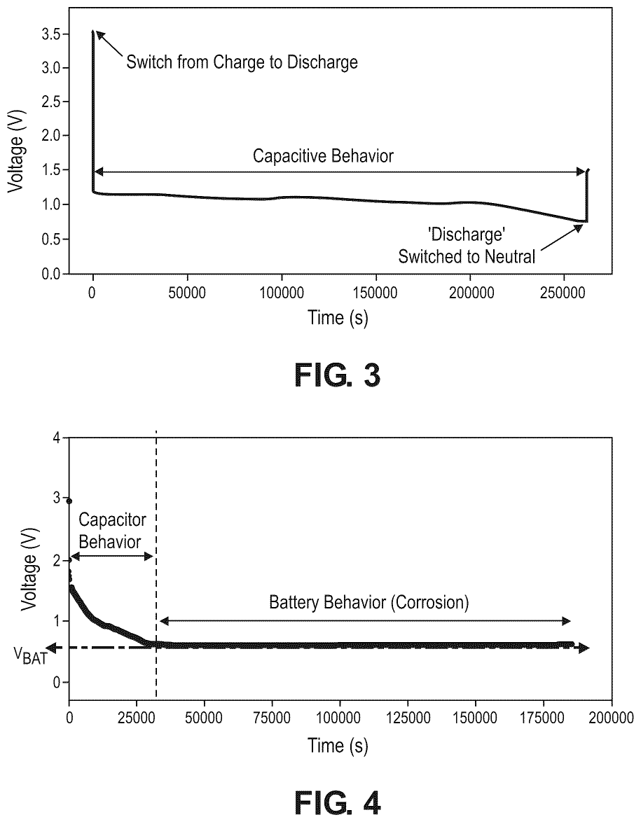

FIG. 3 is a plot illustrating discharge data for an outer dielectric capacitor device configuration showing voltage as a function of time, in accordance with the present disclosure. In particular it shows voltage, as function of time, for a fully charged capacitor of this configuration with electrodes of approximately 4 cm×4 cm dimensions, discharged through a 1.7 kOhm resistor using a standard RC time constant circuit, illustrated elsewhere (F. J. Quintero-Cortes, A. Suarez and J. Phillips, ‘Towards a Universal Model of High Energy Density Capacitors’, Book: Innovations in Engineered Porous Materials for Energy Generation and Storage Applications’, pgs. 343-389, CRC Press (2018).

Results shown in FIG. 3 are representative of multiple, 19 in total, recorded over 77 days, discharges of the device. It should be noted that to discharge (FIG. 3) from ˜1.3 volts to ˜0.7 V took about 260,000 seconds or 2.6 days, from the time the switch was changed from charge to discharge to when discharge was switched to a neutral position. The results shown here in FIG. 3, for the 19th discharge were very similar to those recorded for the first 18 discharges. This result indicates that the devices does not loose activity/capacity over many cycles.

FIG. 4 is a plot illustrating energy measured over a load as a function of time for an MEC, designed as in FIG. 2. (Note: The plotted energy (J) data derived from voltage and resistance measures during for the same time period as shown in FIG. 3 for voltage.) The data clearly illustrates that the energy discharged through the 1.7 kOhm load is high once normalized to the standard Joules/gm. Indeed, the MEC that produced this curve had 0.25 gm of carbon, hence the energy stored was approximately 700 J/gm carbon. A commercial supercapacitor generally has less than 30 J/gm of carbon.

The voltage vs time data of FIG. 3, was used to determine a capacitance, 1100 F/g-carbon, employing this standard text book formula for discharge through a constant resistance:

$$ln ( \frac{V}{{V}_{0}} ) = - t / RC \qquad ( 1 )$$

Standard commercial supercapacitors have a capacitance of ˜8 F/g. Clearly the MEC capacitor shows much larger capacitance values as compared to a commercial capacitor. Furthermore, given the low weight of this capacitor, the energy/gram of the carbon electrode is approximately 700 J/gm, a value computed from this standard equation:

$$ln ( \frac{V}{{V}_{0}} ) = - t / RC \qquad ( 1 )$$

Wherein Vₘₐₓ is the initial voltage of the discharge and Vₘᵢₙ is the final voltage of the discharge. With cost of the materials used being set to $10/kg, this translates to approximately $50/kWh. This cost of the materials, and note 70% of the cost is for the low-cost carbon, can be compared to a low cost lithium-ion battery cost of $170/kWh. The MEC in the outer dielectric capacitor configuration (FIGS. 1 and 2) costs approximately 2% the cost of a low cost supercapacitor on an energy storage basis.

The outer dielectric capacitor configuration was also used to distinguish between capacitive and battery operation, as shown in FIG. 4. To understand this diagram, it is first necessary to explain the voltage at which there is a transition from a steady logarithmic decay in voltage with time, to a voltage which is constant in time. This voltage point is not the same as the OCV because the load has a relatively low resistance value (1700 Ohms) hence significant current is flowing. This voltage, a function of circuit element is herein called the battery voltage (V_{BAT}). It is less than the open circuit voltage (V_{OC}) but is related to the open circuit voltage (V_{OC}). That is, V_{BAT} is only a fraction of the true OCV (labelled V_{OC} in equations). The fraction of the voltage appearing across the load is determined by the ratio of the device output resistance to the load resistance, as given in Equation 2, where RL is the resistance of load, and Rₒᵤₜ is the low frequency (<1 Hz) output resistance of the capacitor:

$${V}_{BAT} = {V}_{OC} * {R}_{L} / ( {R}_{L} + {R}_{out} ) \qquad ( 3 )$$

It should be noted that as the initial voltage for a charged device, V_{C}, is far larger than V_{BAT}, the device discharges as a capacitor initially (FIG. 4, through ˜30,000 sec). In a capacitor voltage declines logarithmically through a constant load. Once the voltage declines to V_{BAT} the operation resembles that of a battery (FIG. 4, from 30,000 sec until ˜190,000 sec). In the battery operation phase, power is derived from corrosion, as explained above, per paragraph 10. As shown by Eq. 3, if the load resistance is much greater than the output resistance, for example R_{L}=10*Rout, V_{BAT} will nearly equal the open circuit voltage, V_{OC}. For example, if R_{L} is 10×Rₒᵤₜ, then V_{BAT}=0.91 V_{OC}. In the event the R_{L} and Rₒᵤₜ are equal, Eq. 1 indicates that the measured voltage V_{BAT}=0.5 V_{OC}. Thus, in designing effective capacitors it is important to minimize Rₒᵤₜ to obtain maximum power across the load.

It should also be noted that many batteries exhibit an increase in effective output resistance with time. This is due to the ‘corrosion’ of the battery electrodes, a necessary part of the battery process. In any event, the increase in the battery output resistance can lead to a drop in the observed voltage across the load. That is, the ‘voltage divider’ circuit is modified to reduce the net voltage across the load. This is generally only observed toward the end of a battery cycle when almost all the ‘corrosion chemistry’ has already transpired. This behavior is not shown in the outer dielectric capacitor configuration of the present disclosure.

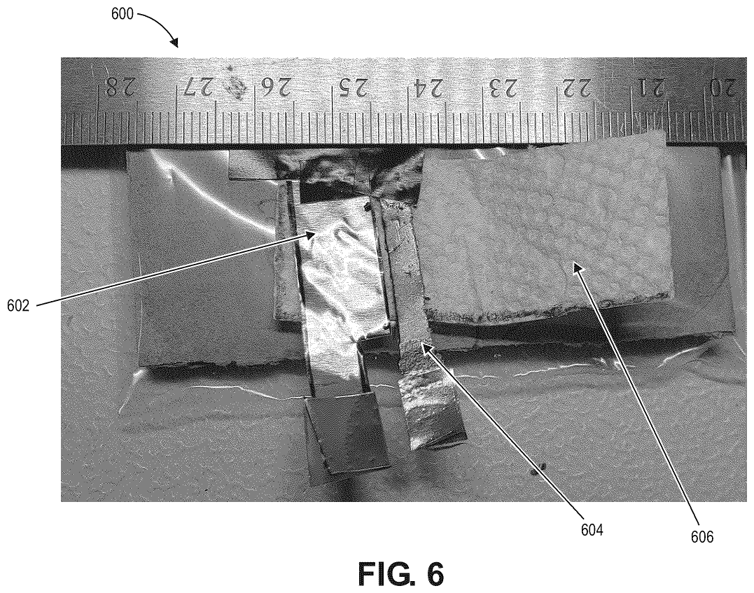

A Side-by-Side MEC includes several of the same materials as other disclosed MECs herein. As illustrated in FIG. 6 it has a first electrode 502 having a connector tab 510 to first electrical connector and a second electrode 504 having a connector tab 512 to second electrical connector. There is a solid absorbent material 506 (shown as transparent) saturated with liquid electrolyte surrounding the first electrode 502 and the second electrode 504 and a narrow, open space 508 between the first electrode 502 and the second electrode 504. It should be noted that the first electrode 502 and the second electrode 504 are of different materials, not on top of each other, and not of the same dimension in this example. The electrodes are separated by an air gap 508. There is no superdielectric material between the first electrode 602 and the second electrode 504, rather the solid absorbent material 506 saturated with liquid electrolyte superdielectric liquid, is wrapped around the outside of the device 500. The thickness of the electrode materials 502, 504 is from about 0.01 cm to about 0.5 cm. The permitted length and width of the electrodes is very broad, ca. from 1 mm to 10 cm. The electrode materials 502, 504 are surrounded on top, bottom, and side by the solid absorbent material 506 saturated with liquid electrolyte. The open space between electrodes 502, 504 can be quite broad, from about 0.001 cm to about 10 cm. Moreover, the dimensions of the two electrodes 502, 504 need not be the same. In real terms, one electrode can be between 1 and 1000× the area of the other

In the Side-by-Side MEC design, each electrode is made of a different conductive material, but unlike the outer dielectric design, there is no overlap of the electrodes. Indeed, the electrodes are placed side-by-side, then wrapped in a physically continuous absorbent material fully saturated with liquid superdielectric. This superdielectric saturated absorbent layer extends over both electrodes, under the two electrodes and top and bottom layers are generally fractionally larger, often approximately 10% larger, than the total electrode dimension, as compared to the outer margins of the two electrodes. The dielectric material is generally a liquid containing a dissolved salt. Typical solvent fluids are ethylene glycol, ethylene glycol, water, or combinations thereof. Typical salts are chlorides (e.g. NaCl), iodides (e.g. KI), sodium benzoate, or combinations thereof. It is also reasonable to employ acids (e.g. Boric acid) or bases (e.g. KOH). The non-conductive absorbent material which is saturated with this liquid dielectric fluid is a flexible, non-conductive material that can be easily shaped to surround the electrodes. Illustrative materials can include paper, nylon, fabrics, or combinations thereof.

MEC of the present disclosure can be distinguished from existing capacitor types. The Side-by-Side MEC design is not comparable to either standard electrolytic or supercapacitor designs. Unlike standard electrolytic capacitors as described and known to those skilled in the art, the two electrodes are not arranged to be on top of one another. Unlike standard electrolytic capacitors, the two electrodes in a MEC are of distinctly different materials. Unlike standard electrolytic capacitors the two electrodes need not have the same dimensions. Unlike standard electrolytic capacitors the high dielectric constant material is not between the electrodes, but rather on the outside.

The Side-by-Side MEC design is also unlike supercapacitors in a significant manner. First, unlike supercapacitors neither electrode in the presently disclosed device has a high surface area. Unlike supercapacitors the two electrodes in the presently disclosed device are made of distinctly different conductive materials. Unlike supercapacitors the electrolyte in the presently disclosed device does not diffuse into the conductive material that compose the electrodes. Unlike supercapacitors, there are no charge collectors in the presently disclosed device. Finally, in a supercapacitor, the separator between electrodes must be porous to allow for ionic transport. In contrast in the Side-by-Side MEC of the present disclosure, there should either be an airgap that is non-porous to ions, or a non-conductive, totally non-porous material.

FIG. 6 is a photograph taken of a Side-by-Side MEC prior to i) wrapping the capacitor with the absorbent electrolyte layer, and ii) before that absorbent layer was saturated with superdielectric fluid, in accordance with the present disclosure. The MEC has a first electrode 602 made of aluminum with an active area of 1 cm by 2 cm, a second electrode 604 made of Grafoil having an active area of 0.4 cm by 2 cm, and an absorbent material 606 made of paper toweling having an area of 2 cm by 5 cm laid open, prior to wrapping both electrodes 602, 604. The absorbent material 606—has been saturated with superdielectric fluid, in this example, glycol with dissolved to the point of saturation with potassium iodide salt.

As in other examples and orientations of devices described herein, the electrodes are made of any two dissimilar, electrically conductive, nearly pure materials. Illustrative materials to be employed as electrodes pairs are copper/carbon, copper/aluminum, aluminum/carbon, zinc/carbon, zinc/copper, tin/carbon, and the like. The electrolyte can be composed of a liquid that can dissolve salts, thus producing mobile ion species. Typical electrolytes can include, but are not limited to, NaCl dissolved in water, KI dissolved in ethylene glycol or other halogen, or alkali earth or alkali metal, transition metal or rare earth containing salts. The electrolyte can also be an acid such as boric acid dissolved in water or other polar fluid or a base such as KOH dissolved in water or other polar fluid.

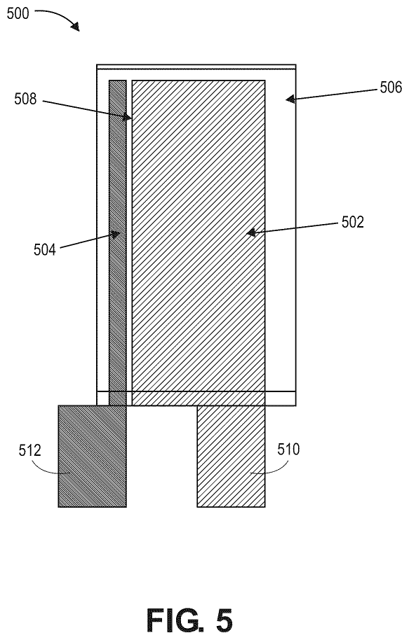

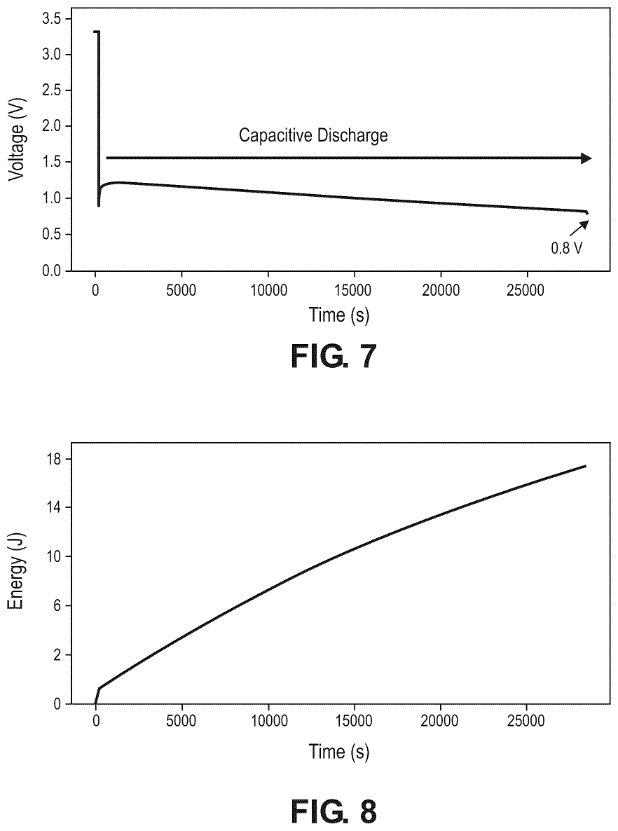

FIG. 7 is a plot illustrating the (voltage) discharge of a Side-by-Side MEC (FIGS. 5 and 6), measured across a 1950 Ohm load, in accordance with the present disclosure. The tested side-by-side MEC contained 0.0125 g of carbon. According to the standard understanding of capacitors with low surface area electrodes, a side-by-side design should have zero capacitance, as the electrodes do not overlap and there is no dielectric sandwiched between them. However, testing results in FIG. 7 show that the side-by-side can exhibit high capacitance/weight.

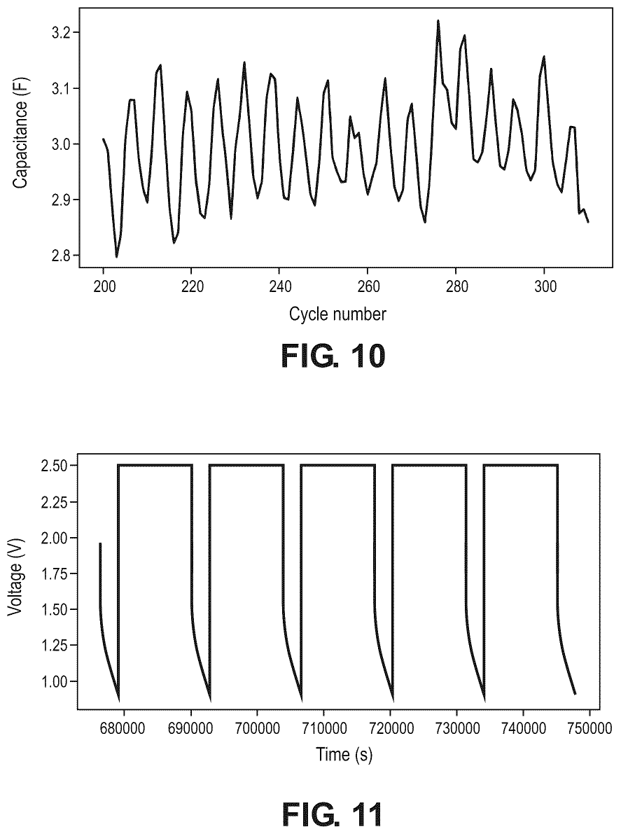

FIG. 8 is a record of the energy dropped across a 1950 Ohm load in an MEC Side-by-Side configuration charged for five hours at 2 volts and containing 0.0125 g of carbon. As the side-by-side MEC used to collect data shown in FIGS. 10 and 11 employed only 0.0125 g of carbon, it can be conservatively stated that there are 1200 J/g released in the discharge. The capacitance, based on Equation 2, is thus 2750 F/g.-carbon, or about 2100 J/gm of carbon, a clearly unprecedented value for a capacitor. By comparison, commercial supercapacitor specifications typically indicate ˜30 J/g.

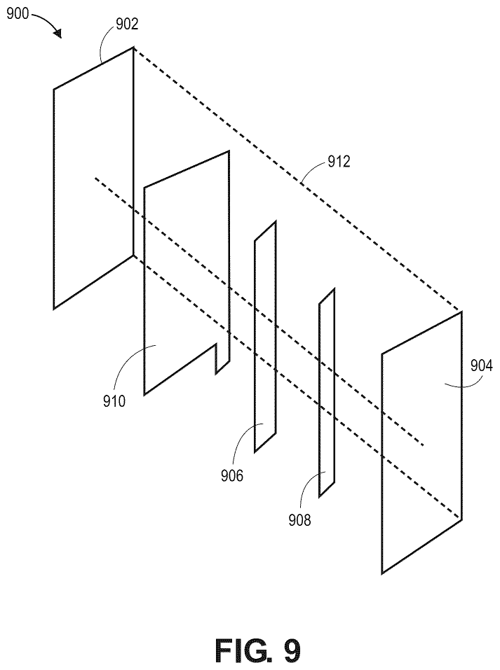

FIG. 9 is a perspective schematic view of a third type of MEC capacitor, a ‘Hybrid MEC’, in accordance with the present disclosure. The Hybrid MEC capacitor 900 includes a first electrolyte layer 902, a first electrode 910, an insulating separator 906, a second electrode 908, and a second electrolyte layer 904, stacked in succession. It should be noted that there is a physical connection 912 between the first electrolyte layer 902 and the second electrolyte layer 904. Again, the first electrode 910 and the second electrode 908 are made of two distinct conductive materials, are not the same size, and are not separated by a high dielectric material, but rather by a very low dielectric constant plastic insulating separator 906. Also, the superdielectric material saturates a highly porous support that is wrapped around the outside of the device. In the Hybrid MEC configuration, unlike the Side-by-Side MEC, the two electrodes are placed directly on top of each other. They must be separated by a non-electrically, non-ion conducting, material to prevent short circuits and ‘leakage’ current. A typical separator material employed in Hybrid MEC is 25 micron thick LDPE. As schematically shown in FIG. 9, the two electrodes are not of the same size. Additionally, each electrode may consist of several layers of materials. For example, there may be two or more layers of the first electrode material, stacked directly on top of each other. There is no superdielectric material between the electrodes. As in the other designs, the superdielectric fluid saturates a porous, absorbent material which forms the outermost layer of the structure. This hybrid structure is also distinct from supercapacitors and electrolytic capacitors. As compared to typical supercapacitors structural distinctions of a hybrid MEC include i) absence of high surface area, porous, conductive material anywhere; ii) a porous separator between the electrode, whereas in typical supercapacitors it is porous, iii) electrolyte material is not absorbed into the electrodes, whereas in a supercapacitor the electrolyte must coat the surface of a highly porous, high surface area, conductive electrode material, iv) the two electrodes are made of distinctly different electrically conductive materials, and v) no ‘current collector’ is included in the structure.

The Hybrid MEC design also distinctly different from electrolytic capacitors. First, unlike electrolytic capacitors, the material between the electrodes (‘separator’) is selected to have a very low dielectric constant. This is the case for the Hybrid MEC because the dielectric constant of the separator is immaterial to its function, hence, the separator is selected on basis that it is non-porous, thin and inexpensive, such as LDPE material generally used in food preservation or wrapping material. In contrast, the net capacitance of an electrostatic capacitor, the capacitor type which most closely resemble the geometry of a Hybrid MEC, is directly proportional to the dielectric constant of the material between the electrodes. Indeed, unlike in the hybrid MEC, it is imperative in any commercial electrolytic capacitor that the dielectric constant of the material between the plates be as high as possible, and that the dielectric layer be as thin as possible. This often leads to the required use of expensive material between the electrodes. Second, the two electrodes in the Hybrid MEC are composed of distinctly different electrically conductive material. In electrolytic capacitors, the two electrodes are composed of the same material. Third, the two electrodes are not necessarily the same size, whereas ideally the two electrodes in an electrolytic capacitor are the same size. Fourth, high dielectric material, specifically, superdielectric material, is present in the Hybrid MEC, but it is not between the electrodes, but rather saturating an absorbent material that forms the outermost active layer of the structure. That is, the high dielectric material required surrounds both electrodes in the Hybrid MEC. In contrast, there is no functioning dielectric in any form on the outermost layer of an electrolytic capacitor. In fact, in a standard electrolytic capacitor the dielectric is always exclusively between the electrodes.

FIG. 10 is a plot illustrating the performance of a Hybrid MEC, exhibiting capacitance over a number of cycles, in accordance with the present disclosure. FIG. 11 is a plot illustrating performance of a hybrid MEC, exhibiting voltage cycles over time, in accordance with the present disclosure. The graphs in FIGS. 10 and 11 are based on the results of a long-term performance of a Hybrid Design MEC. The graph in FIG. 11 shows that the energy/discharge cycle, in capacitance (F) does not diminish as a function of time. This is further evidence of the non-corrosive, long life feature of MEC.

### Mechanism

A speculative mechanism regarding electrical energy storage mechanism is presented below. The validity or non-validity of this model does not impact the invention claims herein. To wit: The marked improvement on a gravimetric basis of the MEC vs. Supercapacitors lead to the suggestion that there is a major difference in the mechanism of charge storage. In standard supercapacitors and electrolytic capacitors, there is a simple charge transfer from one electrode to the other. The capacitor itself never has net charge. Charge enters one electrode, and an equivalent amount of charge leaves the other electrode. This satisfies Kirchoff's Law, in that the net current in and out of capacitor is zero both during charging and discharging. For this reason there is no charge build-up on the capacitor, and the NET charge on the capacitor is zero. However, the two electrodes do not have the same amount of electrons. Essentially, one electrode gains electrons at exactly the rate the other electrode losses them. Thus, before discharge begins there is a difference in the amount of charge on the two electrodes. This ‘imbalance’ is the mechanism for creating a voltage and for electrons to move from the electrode with an excess of negative charge, to the electrode with an excess of positive charge.

In contrast, the MEC and devices as described herein, are arranged more like a battery. As in a battery there is a natural voltage difference between the electrodes, because the two electrodes are made of distinct conductive materials. This leads to a natural voltage difference which is attributed in physics models to the distinct Fermi levels of the two electrodes, whereas in electrochemistry this voltage difference would be attributed to the electrode materials exhibiting different potentials relative to the Standard Hydrogen Electrode. By whatever mechanism or name this fundamental difference in ‘potential’ between the two electrode materials leads to a natural separation of positively charged and negatively charged ions within the ‘superdielectric’ once the electrodes are connected. For example, a typical superdielectric consists of a solution of KI (potassium iodide) dissolved in ethylene glycol. The KI in solution is present as K+ ions and I− ions. The K+ ions will move naturally toward the more ‘negative’ electrode, and the I− toward the ‘positive’ electrode. This diffusion of ions of different charges within the dielectric material leads to significant charge separation on the electrodes. Additional deliberate charging requires more electron and ion density to reach the charge voltage. Hypothetically, this is because the separated charges on the superdielectric material, ‘cancels’ the field due to charge separation. This serves to reduce the field at every point in space due to the charges on the electrodes. As voltage is the integral of the field over a path, to reach any voltage more charges must be placed on the electrodes to overcome the field reduction due to the superdielectric material. Finally, as capacitance is the amount of charge required to reach a given voltage, requiring more charge to reach a specific voltage increases capacitance.

MEC are distinct from both batteries and capacitors while having features similar to both. There are structural differences, ‘operational’ differences, chemical/mechanism differences, and as a result, performance and lifetime differences between batteries/capacitors and MEC. To begin, consider the contrast with batteries. Structure: Clearly there are physical similarities with batteries, for example both batteries and MEC have electrically conductive electrodes of distinct materials. Yet, unlike batteries, MEC, in all the various forms described above and related geometric forms, require a layer of superdielectric material on the outside of the electrodes. Without this layer MEC of any design are non-functioning. Operation: Many battery couples, particularly those favored for MEC Capacitors, such as aluminum (anode)-carbon (cathode) and tin(anode)-air, are primary batteries. Batteries with these electrodes convert chemical energy generated by a chemical corrosion processes into electrical energy that can be delivered to a load. Thus, once the anode (e.g. aluminum in aluminum-carbon battery) is fully corroded (e.g. all aluminum is converted to aluminum oxide), no more energy will be generated. Moreover, as per the definition of primary batteries, batteries of this type are not re-chargeable. In contrast, all types of MEC, including those with one aluminum and one carbon electrode, can repeatedly be re-charged. Second, there is a difference in operation even relative to that of rechargeable type batteries, such as lithium ion or lead acid. Specifically, the MEC is charged to a voltage significantly higher than the open circuit voltage. This is not done with typical batteries. Indeed, rechargeable batteries, so-called secondary batteries, can only be recharged to the open circuit voltage. Third, for both primary and secondary batteries the voltage operating regions of a battery and a MEC are totally non-overlapping. The MEC only operates above the open circuit voltage and a battery with the same electrode materials only operates at or below the open circuit voltage. For example, some of the aluminum anode/carbon cathode batteries described below are charged to ˜1.8 volts, and operate until they reach the open circuit voltage of ˜0.8 V. An aluminum battery, primary, using the same electrodes only operates below 0.8 Volts. Clearly, MEC are always operated at a higher voltage than batteries with the same two electrode materials. Fourth, a battery operates at virtually a constant voltage. This voltage is a function of the free energy change of the chemical corrosion process that generates the electrical energy. In contrast, like all capacitors, the MEC capacitor operates over a range of voltages. In the case of discharge across a load of constant resistance, the MEC voltage decreases exponentially in precisely the same fashion as a standard capacitor of any design. For any type of load, including variable, there is a correlation between the degree of charging and the voltage: As charge bleeds off capacitors as they send current through the load, the voltage delivered decreases. This is clearly the case for MECs and devices as described herein.

MEC differ from capacitors in all the categories listed as well. Structure: Unlike capacitors the electrodes in an MEC are always made of different conductive materials. Unlike supercapacitors, MEC do not have any high surface area material. Most significant: Only MEC have the dielectric material on the outside of the electrodes. Electrolytic capacitors, standard capacitors with a structure most similar to MEC, always have the operational dielectric between the electrodes. Operation: The operating voltage range of MEC is limited to the range between the charge voltage and the OCV, whereas capacitors can be discharged from the charging voltage to zero voltage.

Finally, it is important to consider the performance and lifetime differences between batteries and capacitors. The mass based energy density of some thoroughly tested MEC are similar to those of some batteries, particularly lead acid batteries. No capacitor, including supercapacitors, approaches this value. In terms of the cost of energy storage, examples are provided in this application of prototypes using materials the net cost of which is a fraction of the ‘factory’ cost of lithium ion batteries, and of the order 2% of the cost of supercapacitors with the same net stored energy. In terms of lifetime, all preliminary data suggests that MEC should last for thousands of cycles.

These difference in structure between MEC and supercapacitors, and electrolytic capacitors, are clearly evident in the various designs with alternate arrangements of electrodes and dielectric specified herein. The true novelty of these arrangements is made evident by test results. For example, the tests show the designs to have significantly higher capacitance and energy density than that of the best performing supercapacitors on a weight and/or volume basis.

The multimaterial electrode capacitor as described herein can include a multimaterial electrode capacitor, which can include: a first electrically conductive electrode, a second electrically conductive electrode, where the first electrically conductive electrode may include a first material and the second electrically conductive electrode may include a second material and the first material is different than the second material. The capacitor also includes a low dielectric material or air gap disposed between the first electrically conductive electrode and the second electrically conductive electrode, where the low dielectric material has a dielectric constant of less than 10 at 1 Hz. The capacitor also includes a continuous high dielectric material that covers more than half of an outer surface of the first electrically conductive electrode and the second electrically conductive electrode, where the continuous high dielectric material has a dielectric constant of more than 105 at 1 Hz. The capacitor also includes where there is no electrical connection between the first electrically conductive electrode and the second electrically conductive electrode. The capacitor also includes where the multimaterial electrode capacitor is configured to be charged with an electrical power source to a voltage greater than an open circuit volt. In examples, the multimaterial electrode capacitor is configured to be charged with an electrical power source to a voltage greater than an open circuit voltage. The multimaterial electrode capacitor where the open circuit voltage is from about 0.6 v to about 0. The open circuit voltage can be from about 0.6 v to about 0.8 v. The multimaterial electrode capacitor can include where the multimaterial electrodes capacitor is configured to be charged from about 2 to about 3 times the open circuit voltage. The multimaterial electrode capacitor can include where the multimaterial electrodes capacitor is discharged to a discharge voltage which is 10% or less below the open circuit voltage. The multimaterial electrodes capacitor can be discharged to a discharge voltage which is 10% or less below the open circuit voltage. The multimaterial electrode capacitor can include where the first electrically conductive electrode may include a carbon-based material and the second electrically conductive electrode may include a metal. The multimaterial electrode capacitor can include where the second electrically conductive electrode may include aluminum, copper, titanium, or a combination thereof. The second electrically conductive electrode may include aluminum, copper, titanium, or a combination thereof. The first electrically conductive electrode may include a first metal and the second electrically conductive electrode may include a second metal. The first electrically conductive electrode may include aluminum. The first electrically conductive electrode may include aluminum, copper, titanium, or a combination thereof. The multimaterial electrode capacitor can include where the second electrically conductive electrode may include a carbon-based material. The second electrically conductive electrode may include a carbon-based material. The multimaterial electrodes capacitor can include where the dielectric material may include a gel-like material. The dielectric material may include a fumed silica and a salt solution. The multimaterial electrode capacitor can include where the dielectric material is a gel like material including fumed silica, water, and a salt. The dielectric material may include a gel-like material. The dielectric material may include a may include a solid oxide powder, a liquid, and a dissolved salt. The dielectric material is a gel like material may include of fumed silica, water, and a salt solution. The dielectric material may include a fumed silica, an organic liquid and a salt. The organic liquid may include ethylene glycol. The organic liquid may include ethylene glycol and chemical agents known to prevent metal corrosion. The dissolved salt may include a salt of an alkali metal. The dissolved salt may include a cationic salt or a zwitterionic salt. The liquid may include water mixed with an organic solvent such as glycol. The dielectric material may include a solid material saturated with a salt solution. The solid material may include a polymer. The solid material may include a fibrous solid. The salt solution may include ethylene glycol, and a salt of an alkali metal. The salt solution may include ethylene glycol and a salt of an alkali earth metal. The salt solution may include water and a salt of an alkali metal. The salt solution may include water and a salt of an alkali earth metal. The salt solution may include a cationic salt. The salt solution may include a zwitterionic salt. The dielectric material may include potassium iodide. The dielectric material may include an absorbent fiber material. The multimaterial electrode capacitor may include an insulating layer separating the first electrically conductive electrode from the second electrically conductive electrode, and where the dielectric material covers one or more surfaces of the first electrically conductive electrode and the second electrically conductive electrode that are not in contact with the insulating layer. The insulating layer may include polyethylene. The dielectric material can form an external layer enclosing the first electrically conductive electrode and the second electrically conductive electrode. The multimaterial electrodes capacitor can be arranged in an outer dielectric configuration. The multimaterial electrodes capacitor can be arranged in a side-by-side configuration or a hybrid configuration.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having.” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A multimaterial electrode capacitor, comprising:
a first electrically conductive electrode;
a second electrically conductive electrode, wherein the first electrically conductive electrode comprises a first material and the second electrically conductive electrode comprises a second material and the first material is different than the second material;
a low dielectric material or air gap disposed between the first electrically conductive electrode and the second electrically conductive electrode, wherein the low dielectric material has a dielectric constant of less than 10 at 1 Hz; and
a continuous high dielectric material that covers more than half of an outer surface of the first electrically conductive electrode and the second electrically conductive electrode, wherein the continuous high dielectric material has a dielectric constant of more than 105 at 1 Hz;
wherein there is no electrical connection between the first electrically conductive electrode and the second electrically conductive electrode; and
wherein the multimaterial electrode capacitor is configured to be charged with an electrical power source to a voltage greater than an open circuit voltage.

2. The multimaterial electrode capacitor of claim 1, wherein the open circuit voltage is from about 0.6V to about 0.8 V.

3. The multimaterial electrode capacitor of claim 1, wherein the multimaterial electrodes capacitor is configured to be charged from about 2 to about 3 times the open circuit voltage.

4. The multimaterial electrode capacitor of claim 1, wherein the multimaterial electrodes capacitor is discharged to a discharge voltage which is 10% or less below the open circuit voltage.

5. The multimaterial electrode capacitor of claim 1, wherein the first electrically conductive electrode comprises a carbon-based material and the second electrically conductive electrode comprises a metal.

6. The multimaterial electrode capacitor of claim 5, wherein the second electrically conductive electrode comprises aluminum, copper, titanium, or a combination thereof.

7. The multimaterial electrodes capacitor of claim 1, wherein the first electrically conductive electrode comprises a first metal and the second electrically conductive electrode comprises a second metal.

8. The multimaterial electrodes capacitor of claim 7, wherein the first electrically conductive electrode comprises aluminum.

9. The multimaterial electrode capacitor of claim 8, wherein the first electrically conductive electrode comprises aluminum, copper, titanium, or a combination thereof.

10. The multimaterial electrode capacitor of claim 1, wherein the second electrically conductive electrode comprises a carbon-based material.

11. The multimaterial electrodes capacitor of claim 1, wherein the dielectric material comprises a gel-like material.

12. The multimaterial electrode capacitor of claim 1, wherein the dielectric material comprises a comprises a solid oxide powder, a liquid, and a dissolved salt.

13. The multimaterial electrode capacitor of claim 12, wherein the dielectric material comprises a fumed silica and a salt solution.

14. The multimaterial electrode capacitor of claim 12, wherein the dielectric material comprises a fumed silica, an organic liquid and a salt.

15. The multimaterial electrode capacitor of claim 1, wherein the dielectric material comprises a solid material saturated with a salt solution.

16. The multimaterial electrode capacitor of claim 15, wherein the solid material comprises a polymer.

17. The multimaterial electrodes capacitor of claim 15, wherein the solid material comprises a fibrous solid.

18. The multimaterial electrode capacitor of claim 15, wherein the salt solution comprises ethylene glycol, and a salt of an alkali metal.

19. The multimaterial electrode capacitor of claim 15, wherein the salt solution comprises water and a salt of an alkali metal.

20. The multimaterial electrode capacitor of claim 1, further comprising an insulating layer separating the first electrically conductive electrode from the second electrically conductive electrode, and the dielectric material covers one or more surfaces of the first electrically conductive electrode and the second electrically conductive electrode that are not in contact with the insulating layer.
